(19) United States
(12) Patent Application Publication
(10) Pub. No.: US 2006/0272130 A1
(43) Pub. Date: Dec. 7, 2006

(54) Vibration-proof handle for vibration compactor

(75) Inventors: Takashi Togami, Kuki-shi (JP); Giichi Tanaka, Minamisaitama-Gun (JP); Yoshinori Takemoto, Souka-shi (JP); Youichi Kobayashi, Kitakatsushika-gun (JP); Kenta Itou, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mikasa Sangyo Co., Ltd., Tokyo (JP)

(21) Appl. No.: 11/342,377

(22) Filed: Jan. 27, 2006

(30) Foreign Application Priority Data
Jun. 6, 2005 (JP) 2005-165892

(51) Int. Cl. B25G 1/10

(52) U.S. Cl. 16/431

(57) ABSTRACT

In a conventional operating handle for an operating machine, the two ends of a vibration-proof rubber are sandwiched between a handle rod and a grip bar, thereby connecting the handle rod and grip bar. The vibration of the handle rod is absorbed by the torsion of the vibration-proof rubber. As a result, the vibration of the handle rod can only be reduced rather than eliminated. In the present invention, a grip bar is attached rotatably to the upper end of a handle rod so as to be capable of a rocking motion, and the swing shock generated when the grip bar oscillates is absorbed by a stopper rubber provided on the handle rod. Thus the vibration of the grip bar can be absorbed efficiently by the rockable rotatably attached portion and the stopper rubber.

### BACKGROUND OF THE INVENTION

1. Field of the Invention

The present invention relates to the improvement of a vibration-proof handle for an operating machine such as a plate compactor or vibrocompactor, for example, which compacts a roadbed or the like by means of vibration.

2. Description of the Related Art

Typically with this type of operating machine, an operating handle for operating the machine body protrudes upward to the rear of the operating machine such that vibration generated by the machine body is transmitted to the operating handle. As a result, the vibration of the operating machine is transmitted directly to an operator holding the operating handle, and the operator is affected adversely by the vibration.

Methods of reducing the vibration from the machine body that is transmitted to the operating handle in this type of operating machine have been under consideration for a long time in the prior art. As a basic method of responding to this problem, a structure has been proposed whereby one end of a vibration-proof rubber is connected to the upper end of left and right handle rods and the other end of the vibration-proof rubber is connected to one end of a handle bar, for example. In so doing, the vibration transmitted from the handle rod is absorbed by the vibration-proof rubber and not transmitted to the handlebar.

However, with this type of handle vibration preventing means, the two ends of the vibration-proof rubber are sandwiched between the upper end of the handle rod and one end of the handlebar, forming an integrally fixed and connected structure, and hence the handle rods and handlebar are connected via the vibration-proof rubber to form an integral constitution. In principle, the vibration of the handle rods is absorbed by the torsion of the vibration-proof rubber so that the vibration is not transmitted to the handlebar, but no matter how superlative the employed vibration-proof rubber is, it is impossible with this structure to prevent the vibration transmitted from the handle rods from being transmitted to the handlebar, and at best, an effect of merely reducing the vibration can be obtained.

### SUMMARY OF THE INVENTION

To solve the problem that arises when a vibration-proof rubber is used in an operating handle for this type of operating machine, it is an object of the present invention to provide a vibration-proof handle for a vibration compactor in which vibration from a handle rod is not absorbed by the torsion of the vibration-proof rubber, but instead a handlebar is attached rotatably to the upper end of the handle rod so as to be capable of a rocking motion, whereby the swing angle shock generated when the handlebar rotates is absorbed by a stopper rubber provided on the handle rod, enabling the vibration of the handlebar to be absorbed efficiently by the rockable rotatably attached portion and the stopper rubber.

As means for solving the problem described above relating to a conventional vibration-proof handle for a vibration compactor, the present invention provides a vibration-proof handle for an operating machine which compacts a roadbed or the like by means of vibration, comprising: left and right handle rods, lower ends of which are connected respectively to the two sides of the operating machine; and a U-shaped grip bar attached rotatably to an upper end of the rod so as to be capable of a rocking motion in the front-rear direction of the machine body. A bearing is provided on the upper end of the rod, an annular stopper rubber is provided below the bearing, a connection fitting for connecting the rod to the grip bar through the insertion of a connecting shaft into the bearing is provided on a lower end of a connecting leg formed on each side of the grip bar, and an insertion port large enough for the bearing to be inserted therein is provided in a lower face of the connection fitting such that an inner peripheral edge of the insertion port is supported by the stopper rubber.

The connection fitting of the grip bar is constituted by a lateral cylindrical body, one side face of which has a side wall provided with a bolt hole, and another side face of which has an open end with no side wall. The connection fitting is connected to the bearing of the handle rod by loosely inserting a tubular nut shaft having a cover plate for sealing the open end from the open end side into a shaft hole of the bearing, which is inserted into the connection fitting through the insertion port in the lower face thereof, and screwing a bolt into the nut shaft through the bolt hole opened in the side face having the side wall.

Alternatively, the connection fitting of the grip bar may be constituted by a vertical cylindrical body, one side face of which has a side wall provided with a bolt hole, another side face of which is an open end having no side wall, and an upper end of which serves as a peaked connecting face. In this case, the connection fitting is connected to the bearing of the handle rod by loosely inserting a tubular nut shaft having a cover plate for sealing the open end from the open end side into a shaft hole of the bearing, which is inserted into the connection fitting through the insertion port in the lower face thereof, and screwing a bolt into the nut shaft through the bolt hole opened in the side face having the side wall.

A bar is formed between the connecting legs on either side of the grip bar by a horizontal pipe, and a metallic solid portion having a function for adding mass to the bar is preferably provided in the interior of the bar formed by the pipe.

In the operating handle of the present invention, the bearing provided on the upper end of the handle rod and the connecting shaft of the connection fitting, provided on the lower end of the connecting legs of the grip bar, are connected rotatably so that the grip bar is capable of a rocking motion. Thus the grip bar is attached rotatably to the handle rod so as to be capable of rocking about the connecting shaft. In this state, vibration from the handle rod is transmitted directly to the grip bar, and hence no vibration preventing means are provided.

However, the connection fitting comprising the connecting shaft has an insertion port opened in its lower face, into which the bearing on the upper end of the handle rod is inserted, and the inner peripheral edge of the insertion port is supported by the stopper rubber provided below the bearing of the handle rod. Hence, when the grip bar oscillates as a result of vibration, the insertion port contacts the stopper rubber, thereby restricting the swing angle, and thus the shock which accompanies swinging of the grip bar is absorbed appropriately, enabling the vibration felt in the hands of an operator of the grip bar to be eliminated efficiently.

When the metallic solid portion for adding mass is provided in the interior of the pipe forming the horizontal portion between the two connecting legs of the grip bar, the solid portion applies resistance to the force of the grip bar which is attempting to swing in the front-rear direction as a result of the vibration. Thus the solid portion functions to control the vibration, and is therefore able to absorb the vibration of the grip bar felt by the operator.

The stopper rubber provided below the bearing of the handle rod may simply be structured as an annular rubber which is fitted below the bearing, and is therefore not used in the swinging direction, unlike the vibration-proof rubber used in conventional vibration preventing means. Thus the stopper rubber is durable. Moreover, since there is no need to fuse a connecting bolt to the rubber integrally, efficient vibration preventing means can be provided at a reasonable cost.

### BRIEF DESCRIPTION OF THE DRAWINGS

FIG. 1 is a perspective view showing the component constitution of an operating handle according to the present invention, prior to assembly;

FIG. 2 is a side view of a vibration compactor to which this operating handle is applied;

FIG. 3 is a partial sectional view of a connecting portion between a handle rod and a grip bar, seen from the direction of a side face of the handle rod;

FIG. 4 is a partial sectional view of the connecting portion between the handle rod and grip bar, seen from the direction of a front face of the handle rod;

FIG. 5 is a partial perspective view showing the member formation before the handle rod and grip bar are connected at the connecting portion;

FIG. 6 is a partial perspective view showing the member formation after the handle rod and grip bar are connected at the connecting portion;

FIG. 7 is a perspective view showing another embodiment of a connection fitting used in the connecting portion between the handle rod and grip bar; and

FIG. 8 is a longitudinal sectional view of the connection fitting shown in FIG. 7.

### DESCRIPTION OF THE PREFERRED EMBODIMENTS

A grip bar connected to the upper end of a handle rod is formed such that a connecting leg on each side is bent at an upward angle of ninety degrees in relation to the handle rod, and a solid portion for adding mass is preferably provided in the interior of the grip bar.

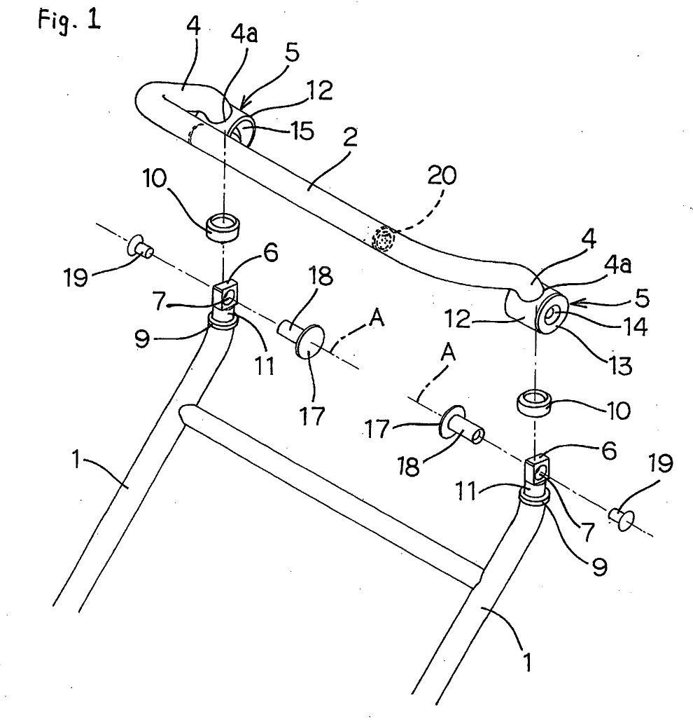

Next, an embodiment of the vibration-proof handle for a vibration compactor according to the present invention will be described on the basis of the drawings. FIG. 1 is an illustrative assembly diagram showing the constitution of a left/right pair of handle rods 1, a grip bar 2 bent into a U shape and provided on the upper end of the handle rods, and various components used to connect the handle rods 1 to the grip bar 2, which together constitute the vibration-proof handle of the present invention.

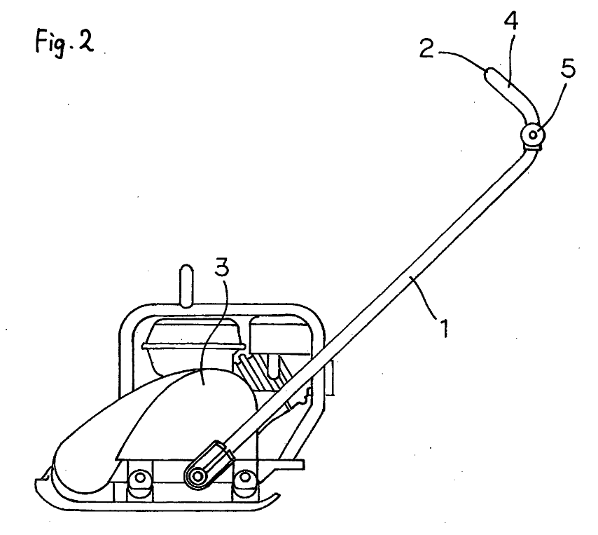

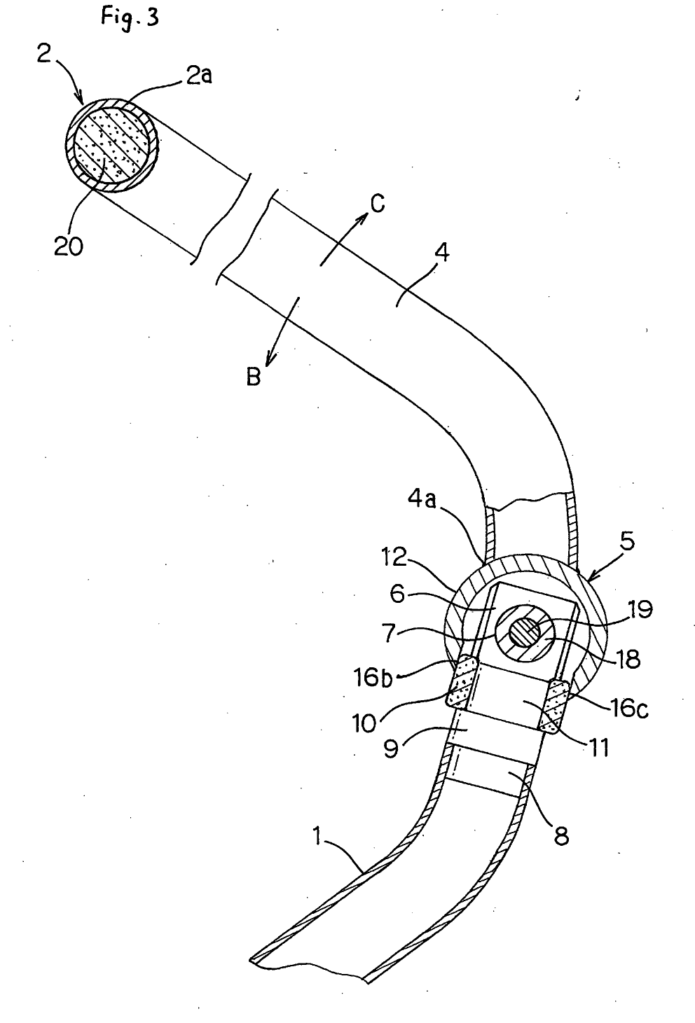

As shown in FIG. 2, the handle rods 1 protrude diagonally rearward from the side face of a vibration compactor 3. As for the grip bar 2, connecting legs 4 on either side thereof are bent at an angle of ninety degrees in relation to the handle rod 1 so as to protrude upward therefrom and, as shown in FIG. 3, a metallic solid portion 20 is provided in the interior of a pipe 2a which forms a horizontal portion between the connecting legs 4, 4 on either side, for adding mass to the bar pipe.

As shown in FIG. 1, the upper end of the handle rod 1 and the connecting leg 4 on each side of the grip bar 2 are attached rotatably via a connection fitting 5, to be described below, so that the grip bar 2 is capable of a rocking motion in the front-rear direction of the machine body.

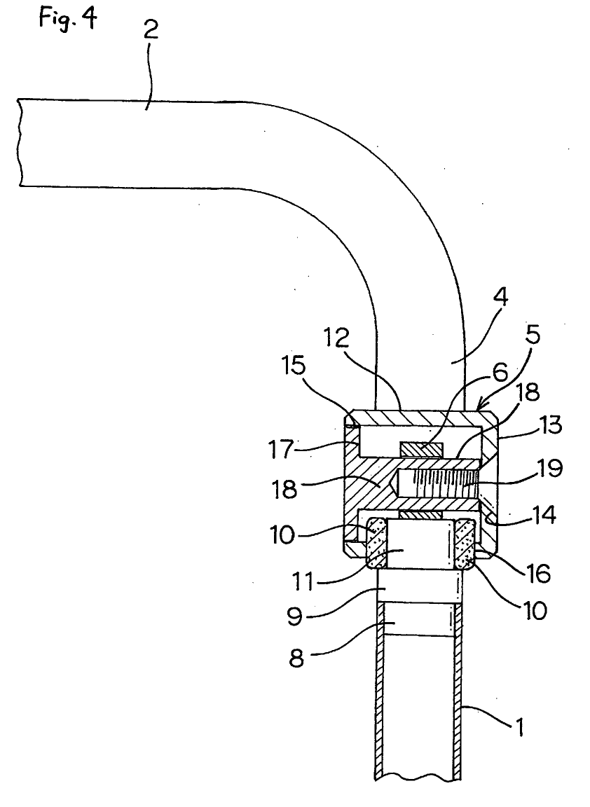

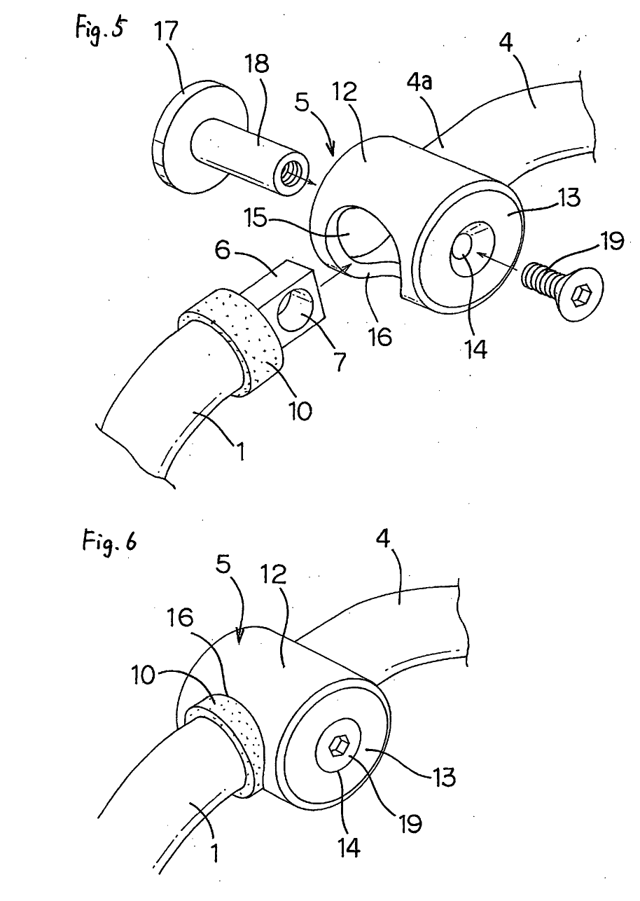

As shown in FIG. 1, a bearing 6 is provided so as to protrude from the upper end of the handle rod 1, and this bearing 6 is provided with a shaft hole 7 oriented such that an axis A linking the upper ends of the left and right handle rods 1, 1 passes therethrough. As shown in FIGS. 3 and 4, an inserted shaft 8 which is inserted into the upper end of the handle rod 1, a flange 9 provided above the inserted shaft 8, a base shaft 11 provided above the flange 9 from which the bearing 6 protrudes, and an annular stopper rubber 10 fitted over the outer periphery of the base shaft 11 and supported in a predetermined position by the flange 9, are provided at the lower end of the bearing 6.

Meanwhile, the lower end of the connecting leg 4 of the grip bar 2 is provided with the connection fitting 5 for connecting the lower end of the connecting leg 4 to the bearing 6 on the upper end of the handle rod 1. The connection fitting 5 is constituted by a lateral cylindrical body 12 provided parallel to the axis A linking the upper ends of the left and right handle rods 1, 1, and comprises on one side face thereof a side wall 13 having a bolt hole 14. The other side face thereof forms an open end 15 with no side wall. The lower end 4a of the grip bar connecting leg 4 is welded to the upper peripheral surface of the cylindrical body 12, and an insertion port 16 for inserting the bearing 6 of the handle rod 1 into the interior of the cylindrical body 12 is provided in the lower peripheral surface of the cylindrical body 12.

When connecting the bearing 6 on the upper end of the handle rod 1 and the connection fitting 5 on the grip bar connecting leg 4, the bearing 6 of the handle rod 1 is inserted into the insertion port 16 provided in the lower peripheral surface of the grip bar connection fitting 5. Next, a tubular nut shaft 18 having a cover plate 17 on one end thereof which is large enough to seal the open end 15 of the connection fitting 5 is inserted loosely into the shaft hole 7 of the bearing 6 inserted into the connection fitting 5 from the open end 15 side, and a bolt 19 is screwed into the tubular nut shaft 18 from the bolt hole 14 opened in the side wall 13 on the opposite side of the open end 15. Thus the bearing 6 of the handle rod 1 and the connection fitting 5 of the grip bar 2 are connected rockably.

Having connected the bearing 6 of the handle rod 1 and the connection fitting 5 of the grip bar 2 to enable a rocking motion about the tubular nut shaft 18 in this manner, when the grip bar 2 rotates in the direction of an arrow B in FIG. 3, an inner peripheral surface 16b of the insertion port 16 on the inside of the connection fitting 5 contacts the outer peripheral surface of the stopper rubber 10, and when the grip bar 2 rotates in the direction of an arrow C, an inner peripheral surface 16c of the insertion port 16 on the outside of the connection fitting 5 contacts the outer peripheral surface of the stopper rubber 10. In both cases, the stopper rubber 10 restricts the rocking angle of the grip bar 2, and absorbs the shock that is generated when the swing angle of the grip bar 2 is restrained.

Further, when the metallic solid portion 20 for adding mass is provided in the interior of the pipe 2a forming the horizontal portion between the two connecting legs 4, 4 of the grip bar 2 as shown in FIG. 3, the solid portion 20 applies resistance which serves as a reactive force against the force of the grip bar 2 which is attempting to rock about the tubular nut shaft 18 in the direction of the arrows B and C. Thus the solid portion 20 functions to control vibration, and is therefore able to eliminate the vibration of the grip bar felt in the hands of an operator efficiently.

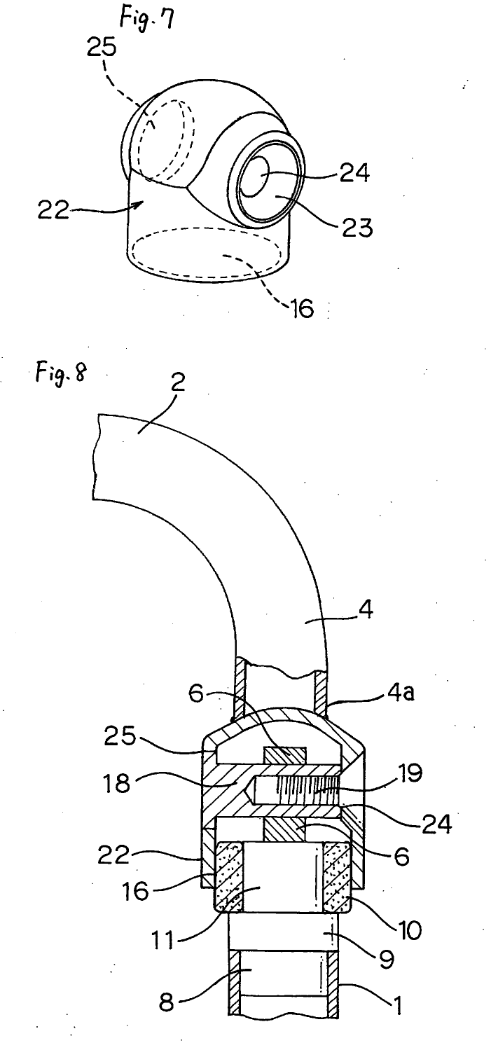

FIGS. 7, 8 show another embodiment of the connection fitting 5. In the previous embodiment, the connection fitting 5 was constituted by the lateral cylindrical body 12 provided parallel to the axis A linking the upper ends of the left and right handle rods 1, 1, whereas in this embodiment, the connection fitting 5 is constituted by a vertical cylindrical body 22 which intersects the axis A linking the upper ends of the left and right handle rods 1, 1.

This embodiment is identical to the previous embodiment in that a side wall 23 having a bolt hole 24 is provided on one side face of the cylindrical body 22, and an open end 25 having no side wall is provided on the other side face. However, the upper end of the cylindrical body 22 forms a peak, and thus the lower end 4a of the grip bar connecting leg 4 can be welded to the upper end of the cylindrical body 22 easily. Furthermore, the open end at the lower end of the cylindrical body 22, which contacts the stopper rubber 10, can be used as an insertion port 26 with no modification. As a result, unlike the lateral cylindrical body 12 of the previous embodiment, there is no need to open the insertion port 16 in the peripheral surface of the cylindrical body using a gas burner, and hence a reduction in cost can be achieved. Moreover, the thickness of the stopper rubber can be increased by enlarging the insertion port, enabling more favorable vibration absorption.

With the vibration-proof handle of the present invention, the upper end of a handle rod and the lower end of a grip bar connecting leg are connected rotatably such that the grip bar is capable of a rocking motion. The swing angle generated when the grip bar connecting leg rocks is absorbed by a stopper rubber, and hence, in comparison with a vibration-proof handle using a conventional vibration-proof rubber, a lower-cost product exhibiting a more favorable vibration absorption effect can be provided.

What is claimed is:

1. A vibration-proof handle for an operating machine such as a vibration compactor which compacts a roadbed or the like by means of vibration, comprising:
left and right handle rods, lower ends of which are connected respectively to the two sides of the operating machine; and
a U-shaped grip bar attached rotatably to an upper end of the rod so as to be capable of a rocking motion in the front-rear direction of the machine body,
wherein a bearing is provided on the upper end of the rod,
an annular stopper rubber is provided below the bearing,
a connection fitting for connecting the rod to the grip bar through the insertion of a connecting shaft into the bearing is provided on a lower end of a connecting leg formed on each side of the grip bar, and
an insertion port large enough for the bearing to be inserted therein is provided in a lower face of the connection fitting such that an inner peripheral edge of the insertion port is supported by the stopper rubber.

2. The vibration-proof handle for a vibration compactor according to claim 1, wherein the connection fitting of the grip bar is constituted by a lateral cylindrical body, one side face of which has a side wall provided with a bolt hole and another side face of which has an open end with no side wall, and
the connection fitting is connected to the bearing of the handle rod by loosely inserting a tubular nut shaft having a cover plate for sealing the open end from the open end side into a shaft hole of the bearing, which is inserted into the connection fitting through the insertion port in the lower face thereof, and screwing a bolt into the nut shaft through the bolt hole opened in the side face having the side wall.

3. The vibration-proof handle for a vibration compactor according to claim 1, wherein the connection fitting of the grip bar is constituted by a vertical cylindrical body, one side face of which has a side wall provided with a bolt hole, another side face of which has an open end with no side wall, and an upper end of which serves as a peaked connecting face, and
the connection fitting is connected to the bearing of the handle rod by loosely inserting a tubular nut shaft having a cover plate for sealing the open end from the open end side into a shaft hole of the bearing, which is inserted into the connection fitting through the insertion port in the lower face thereof, and screwing a bolt into the nut shaft through the bolt hole opened in the side face having the side wall.

4. The vibration-proof handle for a vibration compactor according to claim 1, wherein a metallic solid portion having a function for adding mass to the grip bar is provided in the interior of a pipe which forms a horizontal portion between the two connecting legs of the grip bar.
